(19) United States
(12) Patent Application Publication
(10) Pub. No.: US 2017/0163771 A1
(43) Pub. Date: Jun. 8, 2017

(54) ENABLING COMMUNICATION BETWEEN DEVICES USING SPLITTER CABLES

(71) Applicant: BAE Systems Informaation and Electronic Systems Integration Inc., Nashua, NH (US)

(72) Inventors: David A. RICHARDS, Merrimack, NH (US); Michael J. CHOINIERE, Merrimack, NH (US); Robert W. COSTANTINO, Milford, NH (US); Mark P. DEVINS, Nashua, NH (US); John R. FRANZINI, Hollis, NH (US); Christopher M. HOULE, Hudson, NH (US); Matthew H. ROBICHAUD, Hudson, NH (US)

(21) Appl. No.: 14/764,233

(22) PCT Filed: Nov. 28, 2014
(86) PCT No.: PCT/US14/67801

§ 371 Date: Jul. 29, 2015

(51) Int. Cl. H04L 29/06; H04L 12/24

(52) U.S. Cl. CPC H04L 69/08; H04L 41/0809

(57) ABSTRACT

A system and method for enabling communication between devices using splitter cables are disclosed. In one example embodiment, the system includes a first device and a second device. Further, the system includes a first splitter cable having a first interface connected to the first device, a second interface connected to the second device and a third interface. Furthermore, the first splitter cable includes an embedded communications interface unit to enable communication between the first device and the second device.

### CROSS-REFERENCE TO RELATED APPLICATIONS

This Application claims rights under 35 USC §119(e) from U.S. Application 61/963,287 filed Nov. 30, 2013, the contents of which are incorporated herein by reference.

### BACKGROUND OF THE INVENTION

Field of the Invention

The present invention relates to enabling communication between devices and more particularly to enabling communication between the devices using splitter cables.

Brief Description of Related Art

In a typical imaging system (e.g., a soldier imaging system), multiple accessory devices are connected to a host device (e.g., handheld device). In existing methods, the host device may require different interfaces and communications protocols (e.g., RS232, RS422, universal serial bus (USB), and so on) for connecting to different accessory devices. This may lead to an increased number of pins and dedicated hardware on the host device to handle communications with the accessory devices. Further, e pins nay require a large number of connectors to allow the accessory devices to be connected at the same time. This may lead to placing of breakout boxes at ends of the connectors or octopus ends to the connectors thereby increasing the complexity in managing the accessory devices in the field.

### SUMMARY OF THE INVENTION

A system and method for enabling communication between devices using splitter cables are disclosed. According to one aspect of the present subject matter, the system includes a first device and a second device. Further, the system includes a first splitter cable having a first interface connected to the first device, a second interface connected to the second device and a third interface. Furthermore, the first splitter cable includes an embedded communications interface unit to enable communication between the first device and second device.

According to another aspect of the subject matter, communication is enabled between a first device and a second device by an embedded communications interface unit of a splitter cable having three interfaces. The first device is connected to a first interface of the splitter cable and the second device is connected to a second interface of the splitter cable.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a block diagram of a system for enabling communication between devices using splitter cables, according to an example embodiment of the present subject matter.

FIG. 2 is a flowchart of a method for enabling communication between devices using splitter cables, according to an example embodiment of the present subject matter.

FIG. 3 is a block diagram of a communications interface unit for enabling communication between devices, according to an example embodiment of the present subject matter.

### DETAILED DESCRIPTION OF THE INVENTION

The exemplary embodiments described herein in detail for illustrative purposes are subject to many variations in structure and design. The present technique includes a handheld device that features a 7 pin, universal serial bus (USB) power and data interface. The USB power and data interface connects to a first interface of a splitter cable and communicates with a communications interface unit embedded in a segment of the splitter cable. Further, the splitter cable includes a second interface for connecting to an accessory device and a third interface for connecting to another splitter cable. The splatter cables can then be daisy chained together to form a physical connection chain back to the handheld device while providing connections to multiple accessory devices.

In an example implementation, data from the accessory devices go to the communications interface unit in each splitter cable and get translated or converted in associated communications interface unit into a common protocol (e.g., RS232, RS422, universal serial bus (USB), and so on) that can be read on the handheld device. In another example implementation, data from the handheld device go to the communications interface unit in the associated splitter cable and get translated or converted in the communications interface unit into a protocol that can be read on the associated accessory device. Each communications interface unit can be operated as both a USB client and host, and when daisy chained together, messaging is aggregated and passed up to the handheld device such that the splitter cables can be attached and removed in a hot swap, plug and play type of operation.

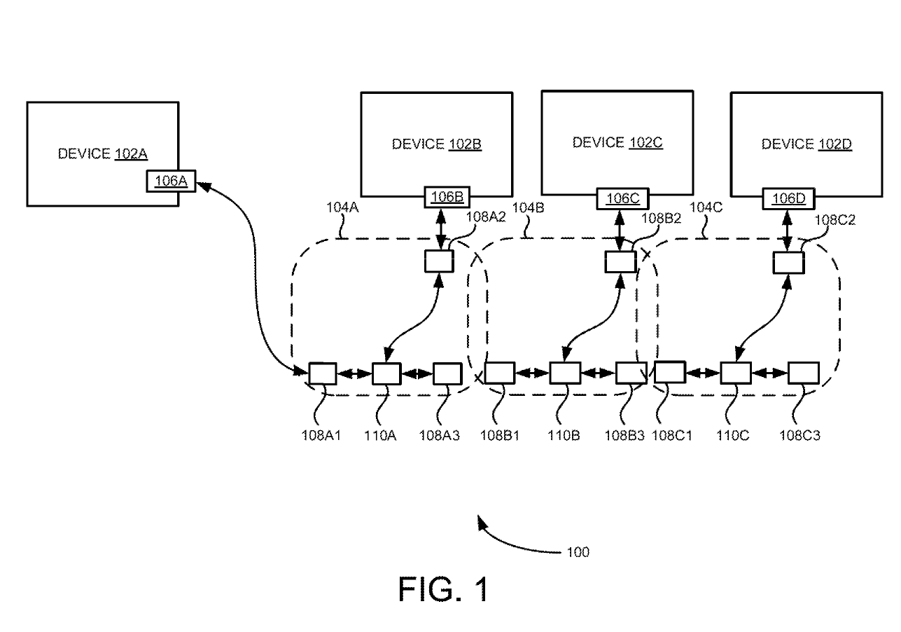

FIG. 1 is a block diagram of a system 100 (e.g., an imaging system and the like) for enabling communication between devices using splitter cables, according to an example embodiment of the present subject matter. As shown in FIG. 1 the system 100 includes devices 102A-D and splitter cables 104A-C. For example, the device 102A is a handheld device (e.g., a handheld targeting location module (HTLM), a laptop, a tablet and so on) and the devices 102B-D are accessory device. Exemplary accessory devices include a power source, a remote actuator, a global positioning system (GPS), a digital record object identification (DRIOD) mission computer, a laser designator, a radio frequency (RF) radio, a camera (serial, USB, camera link, etc.), a smart sensor (pressure, accelerometers temperature), a motor controller, and the like. Further,the devices 102A-D include interfaces 106A-D, respectively. For example, the interface 106A can be a 7 pin, universal serial bus (USB) power and data interface for external power (input), external power ground (GND) (input), USB transmitter (Tx), USB receiver (Rx), USB Vbus+ (out), USB Vbus− (out) and a marker fire.

Furthermore, the splitter cables 104A-C include interfaces 108A1-A3 to 108C1-C3 and communications interface units 110A-C, respectively. The communications interface units 110A-C are embedded in splitter cables 104A-C, for example, in segments between the associated interfaces 108A1-A3 to 108C1-C3. One can envision that a communications interface unit can include logical circuitry or a processor and a memory including instructions run by the processor.

In the example illustrated in FIG. 1, the interface 108A1 of the splitter cable 104A is connected to the interface 106A of the device 102A. In an example, the interface 108A1 of the splitter cable 104A can be connected to the interface 106A of the device 102A via an extended cable. For example, the extended cable can be of length 1 metre (m) to 3 m length. Further, the interface 108A2 is connected to the interface 10613 of the device 102B via any sized cable.

Furthermore, the interface 108A3 is connected to the interface 108B1 of the splitter cable 104B, the interface 108B2 of the splitter cable 104B is connected to the interface 106C of the device 102C via any sized cable and the interface 108B3 of the splitter cable 10413 is connected to the interface 108C1 of the splitter cable 104C. In addition, the interface 108C2 of the splitter cable 104C is connected to the interface 106D of the device 102D via any sized cable. Thus forming daisy chained splitter cables 104A-C and connecting the devices 102B-C to the device 102A via the splitter cables 104A-C. In an example, a GPS, a DRIOD mission computer, a laser designator, a RF Radio and the like can connect to a HTLM. In another example, cameras (serial USB, camera link, etc.), smart sensors (pressure, accelerometers, and temperature) motor controllers, and the like can connect to a laptop, or a tablet. In an example implementation, the devices 102A-C can connect to the device 104D for power or to use remote applications on the device 102D. Each of the communications interface units 110A-C may include protocols supported by associated connected devices 102A-D.

In some embodiments, the splitter cables 104A-C may he different due to connectors on the interfaces (108A2, 108B2 and 108C2) that connect to the devices 102B-D. As such a communications interface unit of a splitter cable knows what type of cable it is and when accessory devices, such as a GPS, a laser marker, a DROID mission computer, and the like plugged in, it may identify itself as a plug and play feature.

In an example implementation, when the splitter cables, 104A-C receive data from devices 102B-D, respectively, the associated communications interface unit 110A-C converts the data into a protocol (e.g., RS232, RS422, USB, and so on) understandable by the device 102A and send the converted data to the device 102A. For example, when the device 102D sends data to the device 102A, the communication interface unit 110C converts the data into the protocol understandable by the device 102A and sends the converted data to the device 102A via the splitter cables 104B and 104A. In another example implementation, when the device 102A sends data to the device 102B, then the communications interface unit 110A converts the data into the protocol understandable by the device 102B and sends the converted data to the device 102B. In yet another example implementation, when the device 102A sends data to the device 102C, then the communications interface unit 110A may send unconverted data to the splitter cable 104B. The communications interface unit 110B then converts the data to the protocol that can be read on the device 102C and sends the converted data to the device 102C. In one example, the protocols that can be understandable by the devices 102A-D can be same or different.

In some embodiments, the splitter cables 104-C can be unique to the connected devices 102A-D. For example, some devices need discrete controls (transistor-transistor logic (TTL) high) to arm a laser or to execute a function like fire a laser. In this example, a handheld device may send a message o data via USB to a communications interface unit to arm and fire the laser. When the communications interface unit receives the message, the communications interface unit may decode the message and generate an aim and fire discrete TTL signal (or interface needs) to fire the laser.

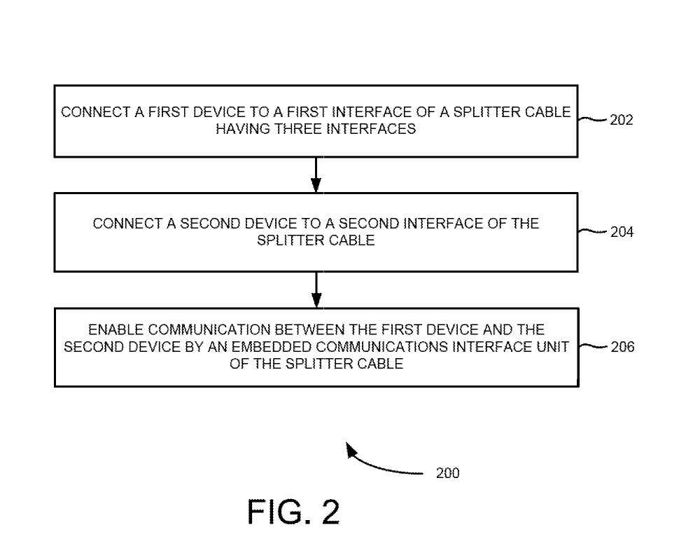

FIG. 2 is a flowchart 200 of a method for enabling communication between devices using splitter cables, according to an example embodiment of the present subject matter. At block 202, a first device connected to a first interface of a splitter cable having three interfaces. At block 204, a second device is connected to a second interface of the splitter cable. For example, the first device includes a handheld device and the second device includes an accessory device. At block 206, communication is enabled between the first device and the second device by an embedded communications interface unit of the splitter cable. In an example implementation, data from the first device is received by the embedded communications interface unit. The data is then converted into a protocol understandable by the second device and sent to the second device by the embedded communications interface unit. In another example implementation, data from the second device is received by the embedded communications interface unit. The data is then converted into a protocol understandable by the first device and sent to the first device by the embedded communications interface unit. In some embodiments, a third interface of the splitter cable is connected to a first interface of another splitter cable which in turn connects to a third device, via a second interface, for connecting with the first device. Thus a daisy chained splitter cables are formed and the devices are connected for communicating with each other. This is explained in more detail with reference to FIG. 1.

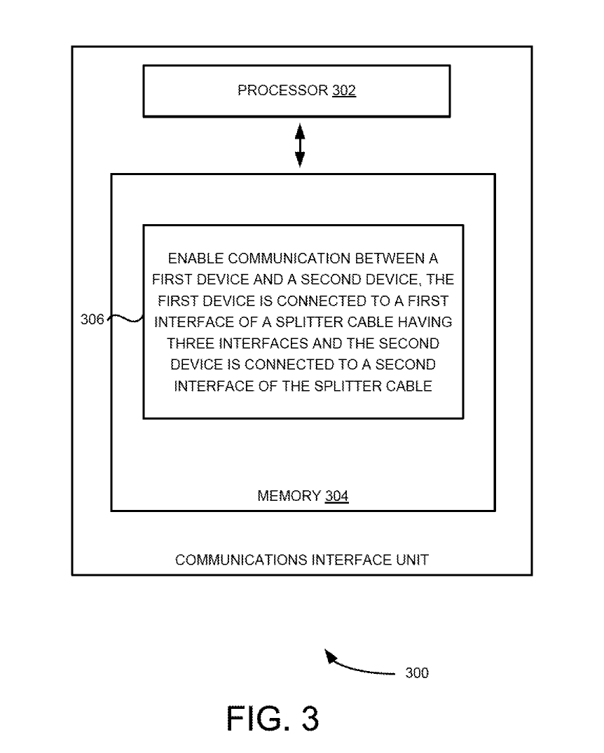

FIG. 3 is a block diagram of a communications interface unit 300 (e.g., one of the communications interface units 110A-C) for enabling communication between devices, according to an example embodiment of the present subject matter. The communications t face unit 300 includes a processor 302 and a memory 304 communicatively coupled through a system bus. The processor 302 may be any type of central processing unit (CPU), microprocessor, or processing logic that interprets dad executes machine-readable instructions stored in the memo 304. The memoir 304 may be a random access memory (RAM) or another type of dynamic storage device that may store information and machine-readable instructions that may be executed by the processor 302. For example, the memory 304 may be, synchronous DRAM (SDRAM), double data rate (DDR), rambus DRAM (RDRAM) rambus RAM, etc. or storage memory media such as a floppy disk, a hard disk, a CD-ROM, a DVD, a pen drive, and the like. In an example, the memory 304 may be a non-transitory machine-readable storage medium. In an example, the memory 304 may be remote but accessible to the communications interface unit 300.

The memory 304 may store instructions 306. In an example, the instructions 306 may be executed by processor 302 to enable communication between a first device and a second device. The first device is connected to a first interface of a splitter cable having three interfaces and the second device is connected to a second interface of the splitter cable.

In various embodiments shown in FIGS. 1-3, the proposed technique enables communication of accessory devices with a handheld device using splitter cables. Using this technique, a number of physical wires required for the communication between the handheld device and accessory devices are significantly reduced, the handheld device, a number of pins of an interface can be reduced from 44 pins to 7, allowing connector sizes to be drastically reduced. Further, new types of accessory devices can communicate with the handheld device by adding instructions to communications interface units in the splitter cable segments and possibly updating instructions in the handheld device without the need to add physical electrical communications lines through a hardware modification. The system portrays each accessory device to the handheld device the same way and the data can be conditioned in the splitter cable segment so that workload on the handheld device can be limited. This data portrayal allows the system to allow a plug and play interface with a graphical user interface on the handheld device. Also, one can envision that this technique can be applied to any groups of devices and net things together on a common bus.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are: contemplated as circumstance may suggest or render expedient, but such are intended to cover the application or implementation without departing from the spirit or scope of the claims of the present:disclosure.

What is claimed is:

1. A system comprising:
a first device and a second device; and
a first splitter cable comprising:
a first interface connected to the first device, a second interface connected to the second device and a third interface; and
an embedded communications interface unit to enable communication between the first device and the second device.

2. The system of claim 1, wherein the embedded communications interface unit is to:
receive data from the first device;
convert the data into a protocol understandable by the second device; and
send the converted data to the second device.

3. The system of claim 1, wherein the embedded communications interface unit is to:
receive data from the second device;
convert the data into a protocol understandable by the first device; and
send the converted data to the first device.

4. The system of claim 1, further comprising:
a second splitter cable having a first interface connected to the third interface of the first splitter cable.

5. The system of claim 1, wherein the first device comprises a handheld device and the second device comprises an accessory device.

6. A method for enabling communication between a first device acid a second device using a splitter cable having three interfaces, the first device connected to a first interface of the splitter cable and the second device connected to a second interface of the splitter cable, the method comprising:
enabling communication between the first device and the second device by an embedded communications interface unit of the splitter cable.

7. The method of claim 6, wherein enabling the communication between the first device and the second device by the embedded communications interface unit of the splitter cable, comprises:
performing at least one of:
receiving data from the first device, converting the data into a protocol understandable by the second device and sending the converted data to the second device, by the embedded communications interface unit of the splitter cable; and
receiving data from the second device, converting the data into a protocol understandable by the first device and sending the converted data to the first device, by the embedded communications interface unit of the splitter cable.

8. The method of claim 6, wherein the first device comprises a handheld device and the second device comprises an accessory device.

9. A system comprising:
a first device and a second device;
a first splitter cable comprising:
a first interface connected to the first device, a second interface connected to the second device and a third interface; and
an embedded communications interface unit to enable communication between the first device and the second device by performing one of:
receiving data from the first device, converting the data, into a protocol understandable by the second device and sending the converted data to the second device; and
receiving data from the second device, converting the data into a protocol understandable by the first device and sending the converted data to the first device; and
a second splitter cable having a first interface connected to the third interface of the first splitter cable.
